(19) United States
(12) Patent Application Publication
(10) Pub. No.: US 2009/0040800 A1
(43) Pub. Date: Feb. 12, 2009

(54) Three phase rectifier and rectification method

(76) Inventors: Maximiliano Sonnaillon, San Diego, CA (US); Alberto Jesus Moreno, San Diego, CA (US); Omar Vitobaldi, Escondido, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/891,673

(22) Filed: Aug. 10, 2007

(51) Int. Cl. H02M 7/04; H02M 7/217

(52) U.S. Cl. 363/89; 363/127

(57) ABSTRACT

A method for converting a three-phase AC voltage to a regulated DC voltage using a three-phase rectifier is disclosed. Both the positive and negative DC currents are controlled, but the inner phase is not controlled. In one embodiment, the AC to DC converter utilizes a three-phase rectifier with low-speed diodes, three low-speed bidirectional switches, two high-speed diodes, two high-speed unidirectional switches, three inductors on the AC side, and two capacitors connected in series.

### BACKGROUND OF THE INVENTION

1. Field of the Invention

The present invention relates generally to an AC-DC converter, and more particularly, to a method for converting a three-phase AC voltage to a regulated DC voltage.

2. Description of the Related Art

Power conversion from AC to DC can be performed in very simple ways with only diodes and an output capacitor. However, in these designs, the current waveforms are not sinusoidal, resulting in a low power factor and a high harmonic content, which can be detrimental to the AC source. To remedy this problem, AC to DC converters may employ high-speed transistors to control the currents in the AC phases to increase power factor and decrease harmonic distortion.

Common AC-DC converters include three-phase inverters with pulse width modulation (PWM), Vienna rectifiers (VR), and Diode Bridge plus Three Level Boost (DB+TLB) rectifiers. PWM inverters provide bidirectional power flow but include six independently controlled high-speed transistors that are both expensive and result in high commutation losses (they commutate between two-levels). Vienna rectifiers provide lower cost and power losses (they commutate between three-levels) but only work for unidirectional power flow. DB+TLB rectifiers provide even lower component cost and power losses. However, they suffer from high current distortion (Total Harmonic Distortion, or THD, is near 30%).

An AC-DC converter design described in U.S. Pat. No. 6,046,915 that is intended to address some of these issues features two inductors located on the DC side, provides for control of the inner phase current, and includes a phase selection circuit and a switching network that are connected to the input of a three-level boost converter. Although this AC-DC converter represents an improvement over the DB+TLB rectifier, this configuration still presents some performance issues.

Although prior art AC-DC converters provide power conversion, the ability to provide a high efficiency, high power factor AC-DC conversion with low cost and high modularity, is limited.

### SUMMARY OF THE INVENTION

In one embodiment, the invention comprises a three phase AC to DC power converter comprising three boost inductors located respectively in each of three AC input phases, a three phase diode bridge coupled to the three boost inductors, at least two output regulating control switches connected in series across the output of the three phase diode bridge, and at least one pair of output capacitors connected in series across the output of the three phase diode bridge. In addition, three bidirectional switches are provided, wherein each bidirectional switch is coupled between a different one of the three boost inductors and a common connection node between the output capacitors and the output regulating control switches. A control circuit is configured to (1) control the output regulating control switches, (2) close the bi-directional switch coupled to the boost inductor connected in the middle input phase, and (3) open the bi-directional switches coupled to the boost inductors connected in the maximum and minimum phases.

In another embodiment, a three phase AC to DC power converter comprises a first voltage sensor measuring voltage across a first output capacitance, a second voltage sensor measuring voltage across a second output capacitance, and an error signal generator coupled to outputs of the voltage sensors and configured to generate at least a first error signal R−T+D and a second error signal R−T−D, where R is the voltage reference, T is the sum of the voltage across the first and second output capacitances and D is the difference between these voltages. A first current sensor is provided in a first current path and a second current sensor in a second current path. An input sensing circuit is further provided having as an input three input phase voltages and having a first output signal derived from the phase having the maximum voltage, a second output signal derived from the phase having the minimum voltage; and a third output signal comprising an identification of a phase having a middle voltage between the maximum and minimum voltages. In addition, a first mixer having as inputs the first error signal from the error signal generator and the first output signal from the input sensing circuit, and a second mixer having as inputs the second error signal from the error signal generator and the second output signal from the input sensing circuit are provided. A pulse width modulation control circuit controls the duty cycle of inductor current control switches based at least in part on outputs of the first current sensor and the first mixer and the second current sensor and the second mixer. Also, a switching circuit is provided having as an input the third output signal from the input sensing circuit and configured to couple the input phase identified by the third output signal to a common connection point between the first output capacitance and the second output capacitance.

In another embodiment, a method of producing a regulated DC voltage from a three phase AC input voltage comprises actively controlling only the currents in the input maximum voltage phase and the input minimum voltage phase.

In another embodiment, a three phase AC to DC power converter comprises a three phase diode bridge, at least two output regulating control switches connected in series across the output of the three phase diode bridge, at least one pair of output capacitors connected in series across the output of the three phase diode bridge, and means for actively controlling only the currents in the maximum voltage input phase and the minimum voltage input phase.

In another embodiment, a three phase AC to DC power converter comprises a three phase diode bridge, at least two output regulating control switches connected in series across the output of the three phase diode bridge, at least one pair of output capacitors connected in series across the output of the three phase diode bridge, and three low speed bidirectional switches. Each low speed bidirectional switch is coupled between a different input phase and a common connection node between the output capacitors and the output regulating control switches, the coupling being made through a high speed bidirectional switch.

### BRIEF DESCRIPTION OF THE DRAWINGS

FIG. 1 illustrates a block diagram of a device for converting a three-phase alternating current (AC) voltage into a regulated, direct current (DC) voltage, in accordance with the embodiments depicted in FIGS. 2, 3, 4, and 5.

FIG. 2 illustrates a device for converting a three-phase alternating current (AC) voltage into a regulated, direct current (DC) voltage, in accordance with one embodiment of the invention.

FIG. 3 illustrates a block diagram of a control system used to implement the devices in FIGS. 1, 2, 4, and 5.

FIG. 4 illustrates an alternate device for converting a three-phase alternating current (AC) voltage into a regulated, direct current (DC) voltage, using a unidirectional switch and a single-phase diode bridge to implement the bidirectional switches.

FIG. 5 illustrates an alternate device for converting a three-phase alternating current (AC) voltage into a regulated, direct current (DC) voltage, integrating the bidirectional switches in the three-phase diode bridge.

FIG. 6 illustrates an alternate block diagram of a device for converting a three-phase alternating current (AC) voltage into a regulated, direct current (DC) voltage, in accordance with the embodiments depicted in FIGS. 7, 8, 9, 10, 11, 12, and 13. The addition of a high-speed bidirectional switch allows a significant reduction in the minimum DC voltage limit.

FIG. 7 illustrates a device for converting a three-phase alternating current (AC) voltage into a regulated, direct current (DC) voltage, using a high-speed bidirectional switch to reduce the minimum DC voltage limit.

FIG. 8 illustrates a block diagram of a control system used to implement the devices in FIGS. 6, 7, 9, 10, 11, 12, and 13.

FIG. 9 illustrates an alternate device for converting a three-phase alternating current (AC) voltage into a regulated, direct current (DC) voltage, using a high-speed unidirectional switch and a single-phase diode bridge to implement the high-speed bidirectional switch.

FIG. 10 illustrates an alternate device for converting a three-phase alternating current (AC) voltage into a regulated, direct current (DC) voltage, connecting the high-speed bidirectional switch between high-speed diodes.

FIG. 11 illustrates an alternate device for converting a three-phase alternating current (AC) voltage into a regulated, direct current (DC) voltage, implementing the low-speed bidirectional switches with a unidirectional switch and a single-phase diode bridge.

FIG. 12 illustrates an alternate device for converting a three-phase alternating current (AC) voltage into a regulated, direct current (DC) voltage, connecting the diodes of each single-phase diode bridge directly to the unidirectional switch of the high-speed bidirectional switch.

FIG. 13 illustrates an alternate device for converting a three-phase alternating current (AC) voltage into a regulated, direct current (DC) voltage, with a different implementation of the low-speed bidirectional switches, which makes use of thyristors or similar devices.

FIG. 14 illustrates an alternate device for converting a three-phase alternating current (AC) voltage into a regulated, direct current (DC) voltage, further including choke coils between the boost inductors and the diode bridge.

FIG. 15 illustrates an alternate device for converting a three-phase alternating current (AC) voltage into a regulated, direct current (DC) voltage, further including choke coils between the diode bridge and the high-speed unidirectional switches.

FIG. 16 illustrates the DC positive and negative currents (DC+ and DC−) in accordance with several embodiments of the invention.

FIG. 17 illustrates the voltages of the AC-DC converter at the upper part in accordance with embodiments shown in FIGS. 2, 3, 4 and 5, of the invention.

### DETAILED DESCRIPTION OF THE PREFERRED EMBODIMENT

While various embodiments of the invention are described below, they are to be construed as illustrative and not restrictive in character. All changes and modifications that are within the understanding of a person of ordinary skill in the art are desired to be protected. For example, a person of ordinary skill in the art would readily understand that some of the functional blocks in the figures illustrating various embodiments may be implemented by control software or by hardware logic or by a firmware comprising of both hardware logic and control software.

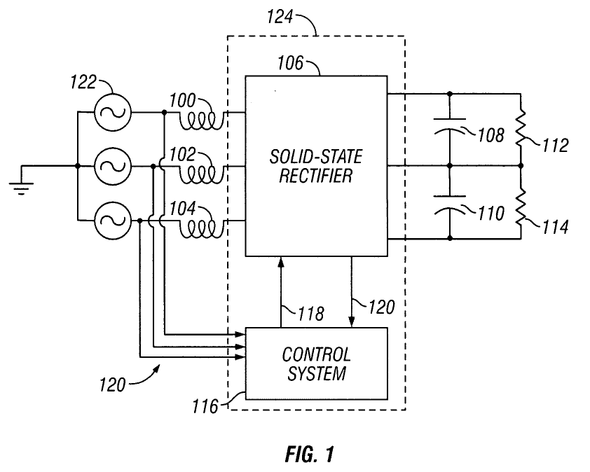

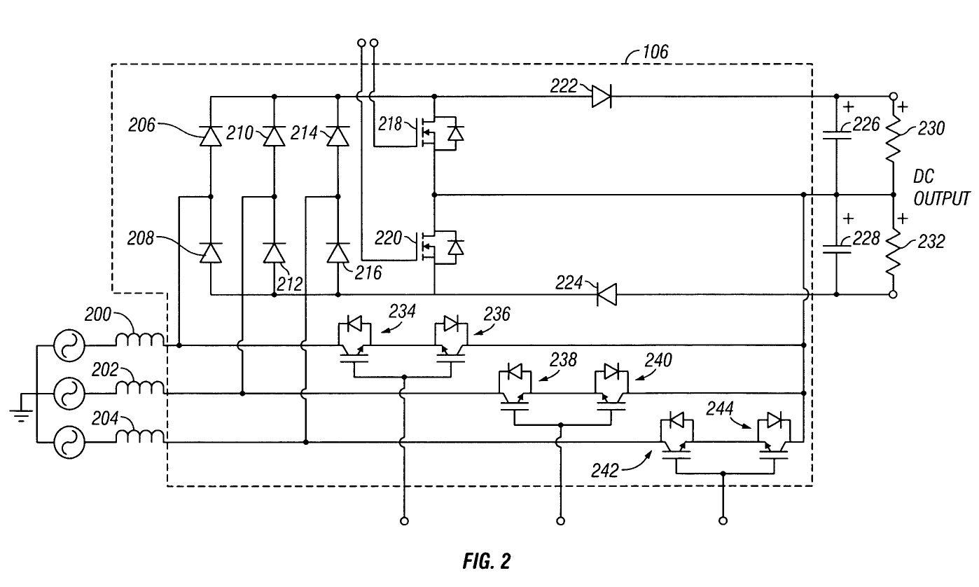

FIG. 1 illustrates a block diagram of a device for converting a three-phase alternating current (AC) voltage into a regulated, direct current (DC) voltage, in accordance with the embodiments depicted in FIGS. 2, 3, 4, and 5. Three inductors 100, 102, and 104, are connected at the device input 122 on the AC side in each input phase. The three inductors 100, 102, and 104, are connected to a solid-state rectifier 106. The solid-state rectifier 106 transmits measured signals 120 to a control system 116. The control system 116 transmits control signals 118 to the solid-state rectifier 106. The solid-state rectifier 106 connects the three inductors 100, 102, and 104, to two capacitors, 108 and 110, as well as to two resistors, 112 and 114, that represent the output load. In many advantageous embodiments, the solid state rectifier 106 (and possibly all or part of the control system 116) are implemented in a single integrated circuit. The control system 116 may be implemented with analog electronics, digital controllers or programmable logic.

FIG. 2 illustrates a device for converting a three-phase alternating current (AC) voltage into a regulated, direct current (DC) voltage, in accordance with one embodiment of the invention. Three boost inductors 200, 202, and 204, are connected at the device input on the AC side. The solid state rectifier 106 is shown within the dashed line of FIG. 2. Three bidirectional switches are implemented with two Insulated Gate Bipolar Transistors (IGBTs) with anti-parallel diode, connected in series and in opposite directions. A first pair of IGBTs, with anti-parallel diode, connected in series, 234 and 236, comprises the first bidirectional switch. A second pair of IGBTs, with anti-parallel diode, connected in series, 238 and 240, comprise the second bidirectional switch. A third pair of IGBTs, with anti-parallel diode, connected in series, 242 and 244, comprise the third bidirectional switch. The three bidirectional switches connect each inductor, 200, 202, and 204, to the center point of the two capacitors, 226 and 228. As explained further below, the bidirectional switches are selectively turned on at a low speed switching frequency by the control circuit. In an alternate embodiment, the three bidirectional switches are implemented with metal-oxide-semiconductor field-effect transistors (MOSFETS) instead of with IGBTs. In one embodiment, the two unidirectional, high-speed switches, 218 and 220, are implemented with MOSFETS, not necessarily with anti-parallel diode. The two unidirectional, high-speed switches, 218 and 220, are connected in parallel to two high-speed diodes, 222 and 224. In an alternate embodiment, the two unidirectional, high-speed switches, 218 and 220, are implemented with IGBTs. The six low-speed, rectifier diodes, 206, 208, 210, 212, 214, and 216, form a three-phase diode bridge. Two resistors, 230 and 232, represent the output load.

In the discussion herein, “low-speed” refers to a switching frequency within an order of magnitude of the input line frequency, typically less than one kilohertz. In contrast, “high-speed” refers to a switching frequency of at least ten kilohertz. High speed switching frequencies in AC-DC converters are often 100 kilohertz or higher.

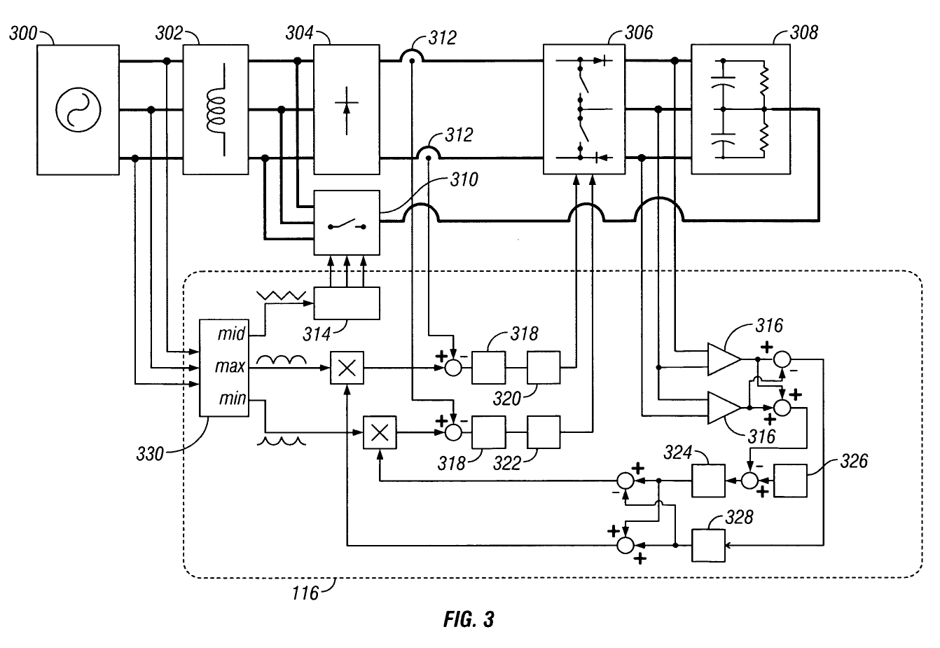

FIG. 3 illustrates a block diagram of a control system (such control system 116 of FIG. 1) that may be used to implement the devices in FIGS. 1, 2, 4, and 5. The control system of FIG. 3 achieves several objectives. The control system reduces harmonic distortion by controlling the phase current waveforms, controls the output DC voltage to a set-point, and controls the mid-point voltage to provide equal DC voltage across each output capacitor. Differential voltage sensors 316 output the voltages across the two output capacitors 226, 228. The output DC voltage (sum of the capacitor voltages) is measured and compared with the voltage reference 326. The voltage error is input into a loop compensator 324. The voltage difference (difference between the capacitor voltages) is input to a second loop compensator 328. The sum and difference of the loop compensator outputs is generated, producing a signal T+D and T−D, where T is the total-voltage loop compensator output and D is the differential-voltage loop compensator output.

Block 330 measures the three phase voltages and determines the maximum value, the minimum value, and the middle voltage. The maximum value refers to the voltage on the phase that has the highest instantaneous value. The maximum voltage output is used as a waveform reference for the positive current controller. The minimum value refers to the voltage on the phase that has the lowest instantaneous value and is used as a waveform reference for the negative current controller. The middle voltage refers to the voltage on the phase that has an instantaneous value between the maximum and the minimum and that does not flow through the diode bridge. The identity of the input phase with the middle voltage is input to block 314, which turns on the corresponding bidirectional switch of FIG. 2 connected to that phase.

The maximum and minimum phase voltage waveforms are multiplied by the voltage controller outputs. The result of these multiplications is used as the instantaneous reference for the two current controllers 318. The current controllers 318 compare the current references with the measured currents 312, on the DC side of the diode bridge 304. Alternatively, currents can be measured on the AC side, by sensing two phase currents and computing the third from the other two (the neutral is not connected). The positive and negative DC currents may be identified by using block 330.

The current errors are passed through loop compensators that determine the duty cycle from 0 to 1 of each unidirectional high-speed transistor 218, 220. Two pulse-width modulators (PWMs), 320 and 322, commutate each switch with the desired duty cycle. In order to reduce the current ripple, the switch commutations of the upper unidirectional switch may be shifted 180 degrees with respect to the lower switch. This is achieved by shifting the respective PWM references by 180 degrees.

The control system of FIG. 3 controls a solid state rectifier (e.g. 106 in FIG. 1) for converting a three-phase alternating current (AC) voltage into a regulated, direct current (DC) voltage, in accordance with several embodiments of the invention. The device contains three inductors 302 connected at the device input 300 on the AC side. Three low-speed, bidirectional switches 310 connect the three inductors 302 to the center point of the two capacitors, 308. The two unidirectional, high-speed switches 306 are connected to output capacitors 308. The six low-speed, rectifier diodes 304 form a three-phase diode bridge.

The above circuit and control method has several advantages over the system descried in U.S. Pat. No. 6,046,915 mentioned above. In this prior patent, the controlled current is the inner phase current, which is AC and with high slopes, such that accurate control of the current is more difficult to achieve than the other two currents (positive and negative currents). If a phase fault (one phase is missing) occurs, then the inner current is zero, and the system must be modified to control the other two currents to allow a correct operation of the system. In addition, the use of only two inductors means that the maximum current ripple is twice the ripple with three inductors. The extra third inductor of the circuit of FIGS. 1 and 2 increments the total inductance by a factor of ½, creating a better maximum ripple over total inductance ratio. Placement of inductors on the DC side also means that a simultaneous turn-on of more than one switch in the phase selection circuit will cause a short-circuit. As such, special considerations must be taken to prevent failures, such as dead times (time when no switch is closed) between switch commutations. Dead times interrupt the inner phase current, producing current distortion in the input phase currents and requiring clamping diodes at the output of the phase selection circuit. In addition, when the phase selection circuit and the switching network are connected at the boost converter input, the current in the boost diodes (high-speed diodes, with high forward voltage) is incremented, increasing power losses.

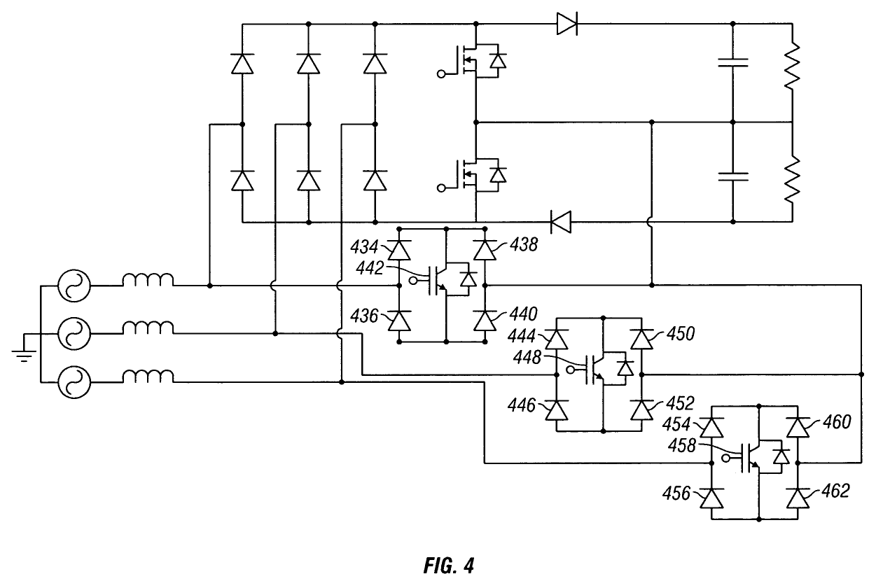

FIG. 4 illustrates another device for converting a three-phase alternating current (AC) voltage into a regulated, direct current (DC) voltage, using a unidirectional switch and a single-phase diode bridge to implement the bidirectional switches. The basic topology of FIG. 4 is similar to the topology of previously described FIG. 2, so to avoid redundancy, the description of FIG. 4 will focus on the use of a unidirectional switch and a single-phase diode bridge to implement the bidirectional switches. In this embodiment, the three bidirectional switches are implemented with one unidirectional switch (IGBT or MOSFET, not necessarily with anti-parallel diode) and a single-phase diode bridge. The first bidirectional switch may include a unidirectional switch 442 (IGBT or MOSFET) and a single-phase diode bridge containing four diodes, 434, 436, 438, and 440. The second bidirectional switch may include a unidirectional switch 448 (IGBT or MOSFET) and a single-phase diode bridge containing four diodes, 444, 446, 450, and 452. The third bidirectional switch may include a unidirectional switch 458 (IGBT or MOSFET) and a single-phase diode bridge containing four diodes, 454, 456, 460, and 462. As with the embodiment of FIG. 2, the three bidirectional switches connect each inductor and to the center point of the two capacitors.

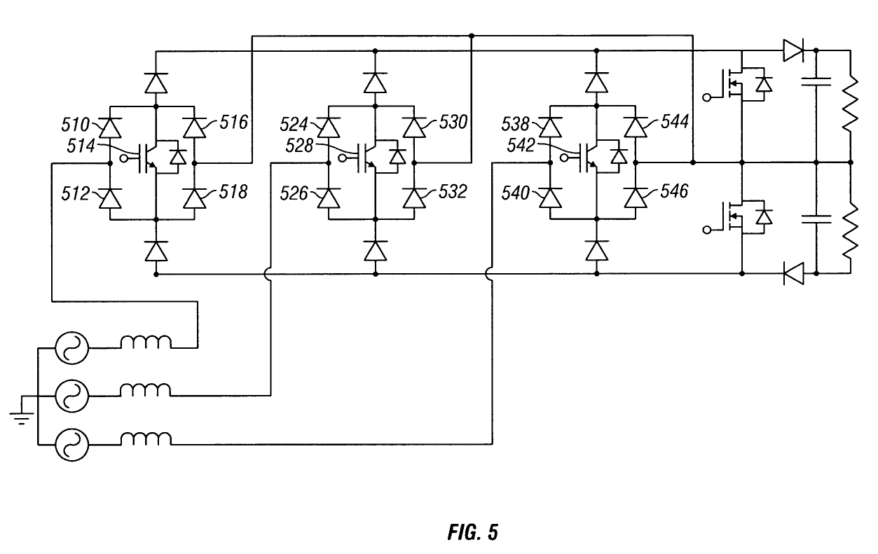

FIG. 5 illustrates a device for converting a three-phase alternating current (AC) voltage into a regulated, direct current (DC) voltage, integrating the bidirectional switches in the three-phase diode bridge. The basic topology of FIG. 5 is similar to the topology of previously described FIG. 2, so to avoid redundancy, the description of FIG. 5 will focus on the integration of the bidirectional switches in the three-phase diode bridge. Three bidirectional switches are implemented with one unidirectional switch (IGBT or MOSFET, not necessarily with anti-parallel diode) and a single-phase diode bridge, and are further integrated into the three-phase diode bridge. The first bidirectional switch may include a unidirectional switch 514 (IGBT or MOSFET) and a single-phase diode bridge containing four diodes, 510, 512, 516, and 518. The second bidirectional switch may include a unidirectional switch 528 (IGBT or MOSFET) and a single-phase diode bridge containing four diodes, 524, 526, 530, and 532. The third bidirectional switch may include a unidirectional switch 542 (IGBT or MOSFET) and a single-phase diode bridge containing four diodes, 538, 540, 544, and 546.

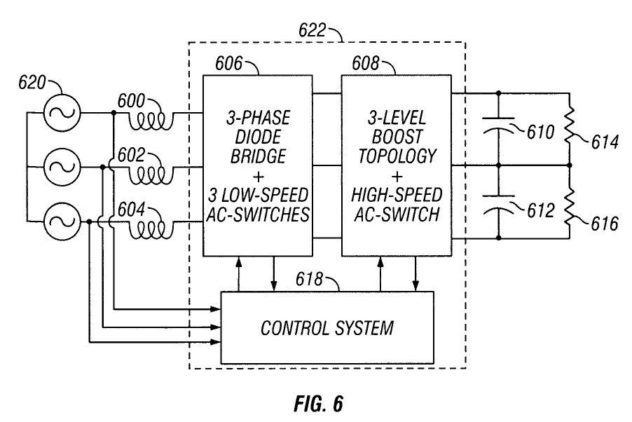

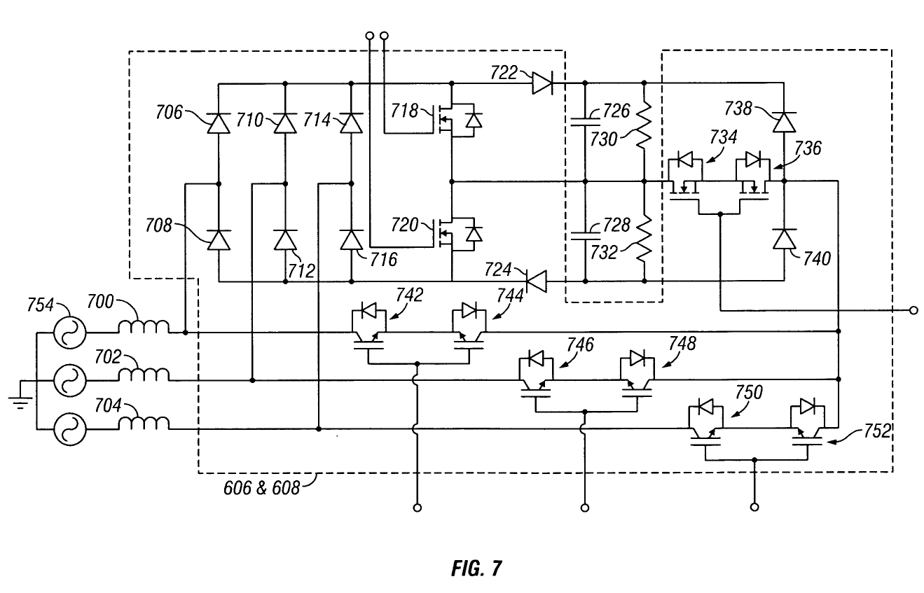

FIG. 6 illustrates a block diagram of a device for converting a three-phase alternating current (AC) voltage into a regulated, direct current (DC) voltage, in accordance with the embodiments depicted in FIGS. 7, 8, 9, 10, 11, 12, and 13. The three inductors 600, 602, and 604, are connected at the device input 620 on the AC side. The three inductors 600, 602, and 604, are connected to a solid-state rectifier consisting of a first part 606 that operates at low-frequency and converts AC voltages to DC voltages, and a second part 608 that operates at high frequency and has the purpose of controlling the current waveforms and regulating the output DC voltages. The addition of a high-speed bidirectional switch in block 608 allows a significant reduction in the minimum DC voltage limit. In one embodiment, the first part 606 of the solid-state rectifier contains a three-phase diode bridge and three low-speed bidirectional switches. In one embodiment, the second part 608 of the solid-state rectifier has a three level boost topology and contains a high-speed bidirectional switch. The solid-state rectifier transmits measured signals to a control system 618. The control system 618 transmits control signals to the solid-state rectifier. The solid-state rectifier connects the three inductors 600, 602, and 604, to two capacitors, 610 and 612, as well as to two resistors, 614 and 616, that represent the output load. As described above, the circuitry 622 of FIG. 6 may be implemented in a single integrated circuit, or split among a plurality of separate integrated circuits.

FIG. 7 illustrates a device for converting a three-phase alternating current (AC) voltage into a regulated, direct current (DC) voltage, using a high-speed bidirectional switch. Three inductors 700, 702, and 704, are connected at the device input 754 on the AC side. Three low-speed, bidirectional switches are implemented with two Insulated Gate Bipolar Transistors (IGBTs) with anti-parallel diode, connected in series and in opposite directions. Low-speed semiconductors commutate at twice the line frequency. A first pair of IGBTs, with anti-parallel diode, connected in series, 742 and 744, comprise the first low-speed, bidirectional switch. A second pair of IGBTs, with anti-parallel diode, connected in series, 746 and 748, comprise the second low-speed, bidirectional switch. A third pair of IGBTs, with anti-parallel diode, connected in series, 750 and 752, comprise the third low-speed, bidirectional switch. A high-speed bidirectional switch is implemented with two MOSFETs, 734 and 736, connected in series and in opposite direction, with a common source. The three low-speed, bidirectional switches connect each inductor, 700, 702, and 704, to the high-speed bidirectional switch and to the two high-speed diodes, 738 and 740. The high-speed bidirectional switch is connected with the capacitors, 726 and 728. The three low-speed bidirectional switches are turned-on one at a time. In an alternate embodiment, the three low-speed, bidirectional switches are implemented with metal-oxide-semiconductor field-effect transistors (MOSFETS) instead of with IGBTs. In one embodiment, the two unidirectional, high-speed switches, 718 and 720, are implemented with MOSFETS. The two unidirectional, high-speed switches, 718 and 720, are connected in parallel to two high-speed diodes, 722 and 724. In an alternate embodiment, the two unidirectional, high-speed switches, 718 and 720, are implemented with IGBTs. The six low-speed, rectifier diodes, 706, 708, 710, 712, 714, and 716, form a three-phase diode bridge. Two resistors, 730 and 732, represent the output load.

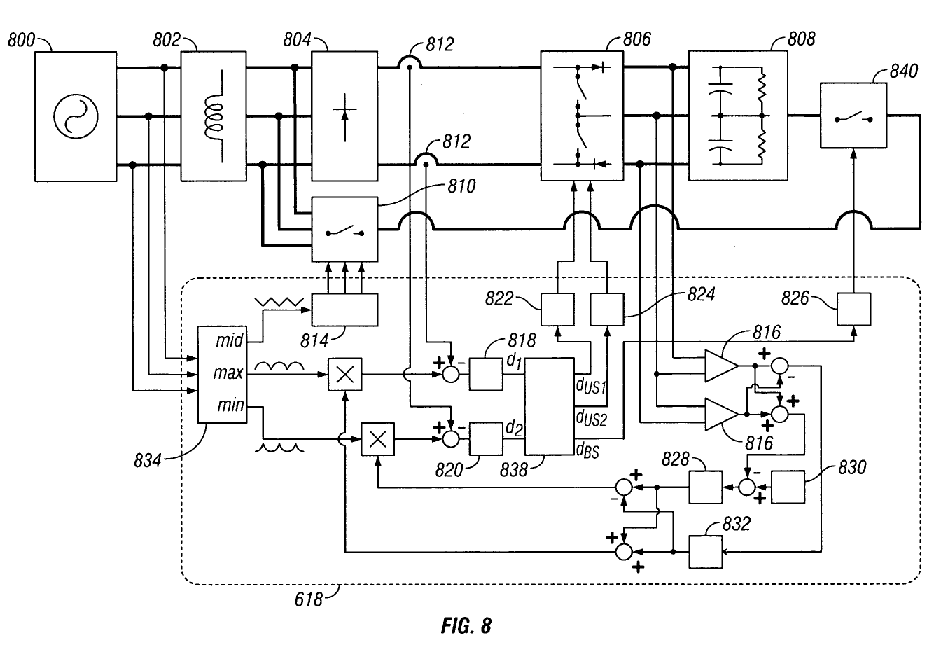

FIG. 8 illustrates a block diagram of a control system (such as the control system 618 of FIG. 6) that may be used to implement the devices in FIGS. 6, 7, 9, 10, 11, 12, and 13. This embodiment is similar to that described above with reference to FIG. 3, except a high-speed bidirectional switch is added to the middle phase current path to lower the minimum necessary DC output voltage.

In this embodiment, the two current controllers, 818 and 820, output two values, d1 and d2. Block 838 analyzes the two values d1 and d2, and determines whether to generate a duty cycle for the three PWMs, 822, 824, and 826, based on an algorithm. If both outputs of the current controllers, d1 and d2, are greater than zero, each output is the duty cycle of its corresponding unidirectional switch (dUS1 and dUS2) and the bidirectional switch is closed for the whole commutation period (dBS=1). However, if one of the current controller outputs, d1 or d2, is lower than zero (this would be an invalid duty cycle), the corresponding unidirectional switch is held open for the entire commutation period (dUSx=0). The high-speed bidirectional switch is commutated with a duty cycle that results from the sum of one plus the duty cycle that was lower than zero (dBS=1+dx). This results in a valid duty cycle (between 0 and 1). The other unidirectional switch (which is greater that zero) is commutated with the duty cycle indicated by its current controller. The algorithm can be explained with the following pseudo-code:

If d1>0 and d2>0, then dUS1=d1, dUS2=d2, dBS=1
If d1>0 and d2≦0, then dUS1=d1, dUS2=0, dBS=1+d2
If d2>0 and d1≦0, then dUS1=0, dUS2=d2, dBS=1+d1

In order to reduce the current ripple, when the first condition is satisfied (both duty cycles are greater than zero), the unidirectional switches commutation may be shifted 180 degrees, as in the previous control method. In the other two cases, the three PWMs are synchronized without phase shift.

The control system controls a device for converting a three-phase alternating current (AC) voltage into a regulated, direct current (DC) voltage (e.g. the solid state circuits 606 and 608 of FIG. 6), in accordance with several embodiments of the invention. The control system of FIG. 8 allows a reduction in the minimum output DC voltage by controlling the high-speed bidirectional switch coupled to the middle phase. The device contains three inductors 802 connected at the device input 800 on the AC side. Three low-speed, bidirectional switches 810 connect one of the three inductors 802 to a bidirectional, high-speed switch, 840, which is also connected to the mid point of the output capacitors, 808. Six low-speed, rectifier diodes 804 form a three-phase diode bridge that connects two of the input inductors, 802, to two unidirectional, high-speed switches, 806. The two unidirectional, high-speed switches 806 are connected to output capacitors 808.

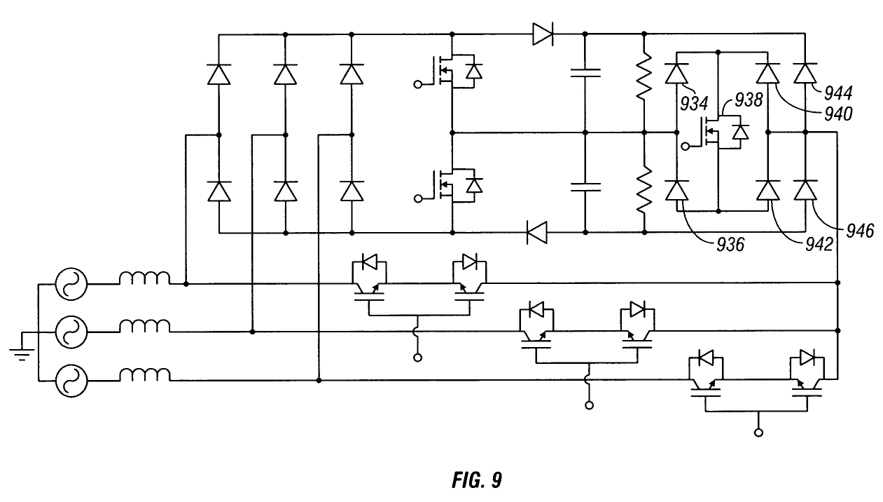

FIG. 9 illustrates a device for converting a three-phase alternating current (AC) voltage into a regulated, direct current (DC) voltage, using a high-speed unidirectional switch and a single-phase diode bridge to implement the high-speed bidirectional switch. The basic topology of FIG. 9 is similar to the topology of previously described FIG. 7, so to avoid redundancy, the description of FIG. 9 will focus on the use of a high-speed unidirectional switch and a single-phase diode bridge to implement the high-speed bidirectional switch. A high-speed bidirectional switch is implemented with a high-speed unidirectional switch, 938 (MOSFET or IGBT, not necessarily with anti-parallel diode), and a single-phase diode bridge consisting of four diodes, 934, 936, 940, and 942. The three low-speed, bidirectional switches connect each inductor to the high-speed bidirectional switch and to the two high-speed diodes, 944 and 946. The high-speed bidirectional switch is connected with the capacitors.

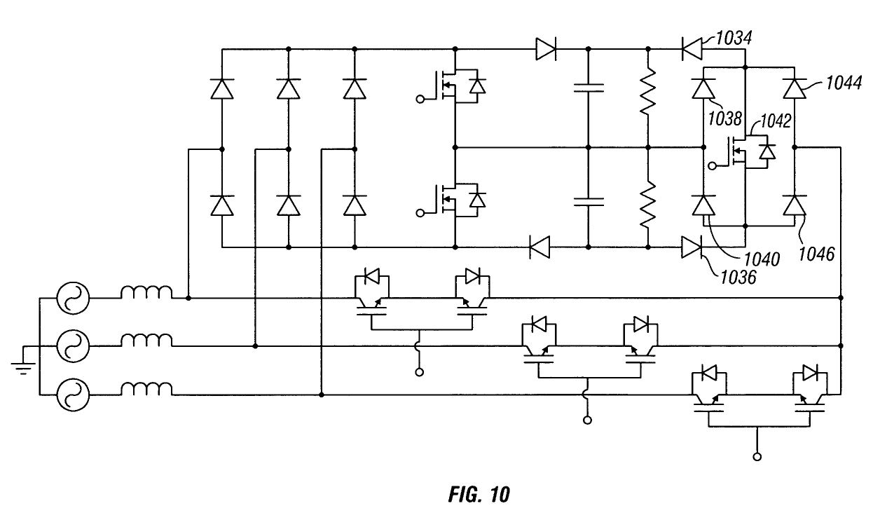

FIG. 10 illustrates a device for converting a three-phase alternating current (AC) voltage into a regulated, direct current (DC) voltage, connecting the high-speed bidirectional switch between high-speed diodes. The basic topology of FIG. 10 is similar to the topology of previously described FIG. 7, so to avoid redundancy, the description of FIG. 10 will focus on connecting the high-speed bidirectional switch between high-speed diodes. A high-speed bidirectional switch is implemented with a high-speed unidirectional switch, 1042 (MOSFET or IGBT, not necessarily with anti-parallel diode), and a single-phase diode bridge consisting of four diodes, 1038, 1040, 1044, and 1046. The three low-speed, bidirectional switches connect each inductor to the high-speed bidirectional switch and to the two high-speed diodes, 1034 and 1036. The high-speed bidirectional switch is connected with the capacitors. In addition, the high-speed bidirectional switch is positioned between the two high-speed diodes, 1034 and 1036.

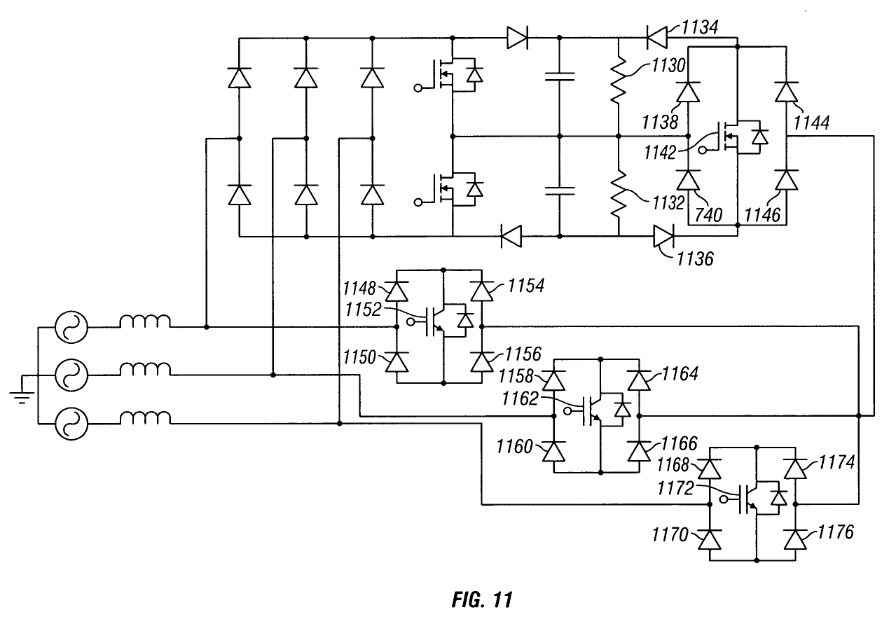

FIG. 11 illustrates a device for converting a three-phase alternating current (AC) voltage into a regulated, direct current (DC) voltage, implementing the low-speed bidirectional switches with a unidirectional switch and a single-phase diode bridge. The basic topology of FIG. 11 is similar to the topology of previously described FIG. 7, so to avoid redundancy, the description of FIG. 11 will focus on implementing the low-speed bidirectional switches with a unidirectional switch and a single-phase diode bridge. Three low-speed, bidirectional switches are implemented with a unidirectional switch (a MOSFET or IGBT, not necessarily with anti-parallel diode) and a single-phase diode bridge. A first low-speed, bidirectional switch contains a unidirectional switch 1152 and four diodes, 1148, 1150, 1154, and 1156. A second low-speed, bidirectional switch contains a unidirectional switch 1162 and four diodes, 1158, 1160, 1164, and 1166. A third low-speed, bidirectional switch contains a unidirectional switch 1172 and four diodes, 1168, 1170, 1174, and 1176. A high-speed bidirectional switch is implemented with a high-speed unidirectional switch, 1142 (MOSFET or IGBT, not necessarily with anti-parallel diode), and a single-phase diode bridge consisting of four diodes, 1138, 1140, 1144, and 1146. The three low-speed, bidirectional switches connect each inductor to the high-speed bidirectional switch and to the two high-speed diodes, 1134 and 1136. In an alternate embodiment, the three low-speed, bidirectional switches are implemented with metal-oxide-semiconductor field-effect transistors (MOSFETS) instead of with IGBTs.

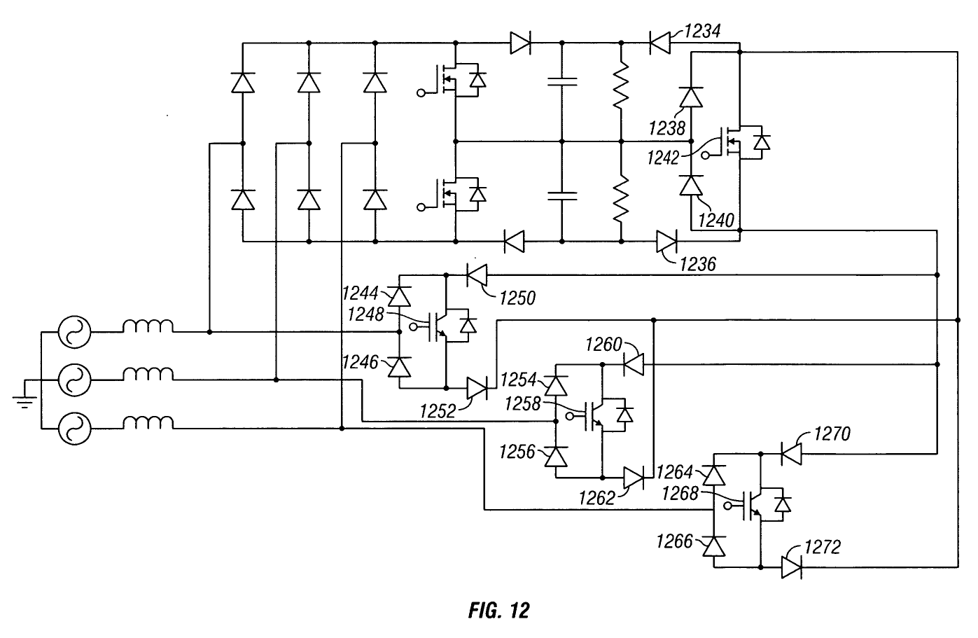

FIG. 12 illustrates a device for converting a three-phase alternating current (AC) voltage into a regulated, direct current (DC) voltage, connecting the diodes of each single-phase diode bridge of the low-speed bidirectional switches directly to the unidirectional switch of the high-speed bidirectional switch. The basic topology of FIG. 12 is similar to the topology of previously described FIG. 7, so to avoid redundancy, the description of FIG. 12 will focus on connecting the diodes of each single-phase diode bridge directly to the unidirectional switch of the high-speed bidirectional switch. Three low-speed, bidirectional switches are implemented with a unidirectional switch (a MOSFET or IGBT, not necessarily with anti-parallel diode) and a single-phase diode bridge. A first low-speed, bidirectional switch contains a unidirectional switch 1248 and four diodes, 1244, 1246, 1250, and 1252. A second low-speed, bidirectional switch contains a unidirectional switch 1258 and four diodes, 1254, 1256, 1260, and 1262. A third low-speed, bidirectional switch contains a unidirectional switch 1268 and four diodes, 1264, 1266, 1270, and 1272. The two diodes at the right side of each diode bridge, 1250, 1252, 1260, 1262, 1270, and 1272, are connected directly to the terminals of the unidirectional switch 1242 in the high-speed bidirectional switch. By using this topology, two diodes are eliminated and thus losses and cost are reduced.

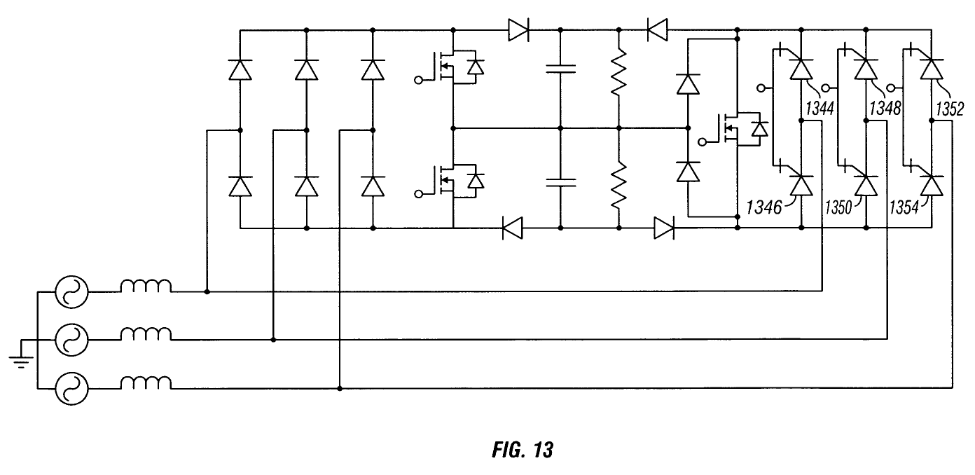

FIG. 13 illustrates a device for converting a three-phase alternating current (AC) voltage into a regulated, direct current (DC) voltage, with a different implementation of the low-speed bidirectional switches. The basic topology of FIG. 13 is similar to the topology of previously described FIG. 12, so to avoid redundancy, the description of FIG. 13 will focus on the novel implementation of the low-speed bidirectional switches. Three low-speed, bidirectional switches are implemented with gate turn-off thyristors (GTOs) having reverse voltage blocking capability. GTOs allow for the elimination of low-speed diodes, reducing losses and cost. In an alternate embodiment, the GTOs can be replaced by a unidirectional switch with reverse voltage blocking capability, such as a combination of an IGBT and a diode. In yet another embodiment, GTOs can be replaced by thyristors with an appropriated turning-off scheme. A first low-speed, bidirectional switch contains two GTOs, 1344 and 1346. A second low-speed, bidirectional switch contains two GTOs, 1348 and 1350. A third low-speed, bidirectional switch contains two GTOs, 1352 and 1354. The three low-speed, bidirectional switches connect each inductor to the high-speed bidirectional switch and to the two high-speed diodes.

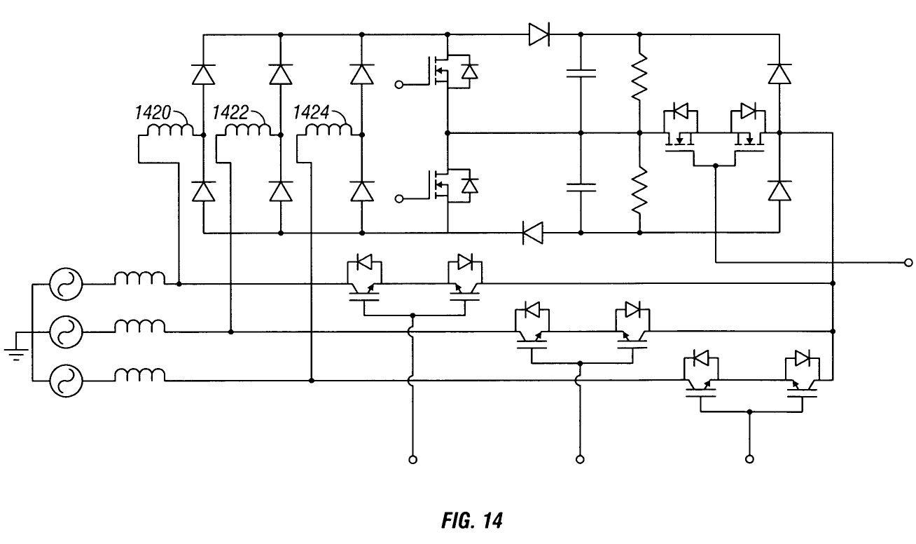

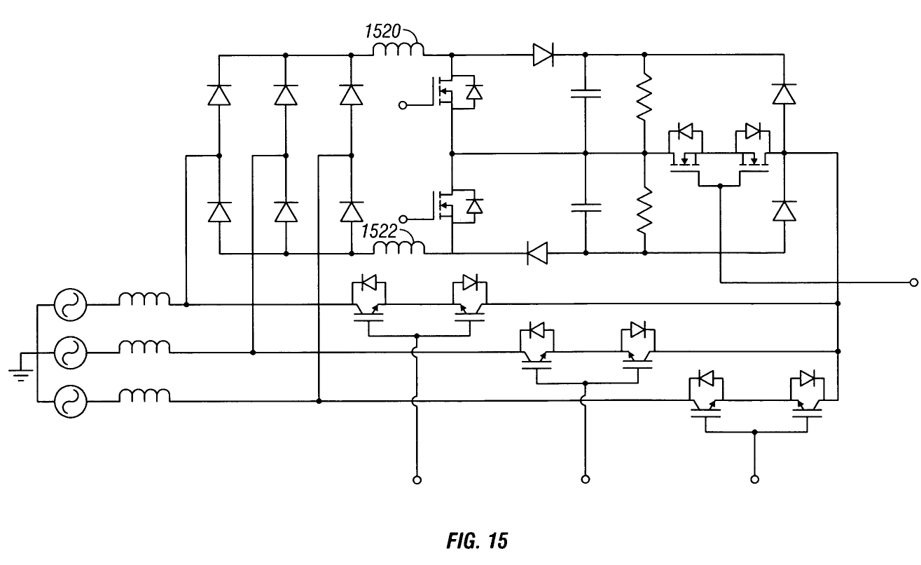

In embodiments of FIGS. 6, 7, 9, 10, 11, 12, and 13 (converters that include the high-speed bidirectional switch), small inductors (chokes) may be placed immediately before (AC side) or after (DC side) the three phase diode bridge. These inductors prevent high frequency current from flowing through the diode bridge instead of the clamping diodes connected to the high-speed bidirectional switch. If high frequency current flows through these slow diodes, power losses can be increased. Hence, the additional small inductors are used to avoid these power losses. These choke coils may be placed on the AC side as shown by inductors 1420, 1422, and 1424 of FIG. 14 which are implemented in the rectifier circuit of FIG. 7. Alternatively, these choke coils may be placed in the DC side as shown by inductors 1520 and 1522 of FIG. 15, also implemented in the rectifier of FIG. 7.

Another embodiment of a converter with these extra inductors has the same schematic diagram of FIG. 15. In this alternative embodiment, the DC inductors 1520 and 1522 are the boost inductors with large inductance, and the three AC inductors connected to the input voltage source are small inductors (choke coils). In this case, the DC inductors may fulfill both the purpose of being part of the boost converter and also filtering the high-frequency currents through the diode bridge. The AC inductors can serve the purpose of avoiding short circuits when the low-speed bidirectional switches commutate the middle phase as described above.

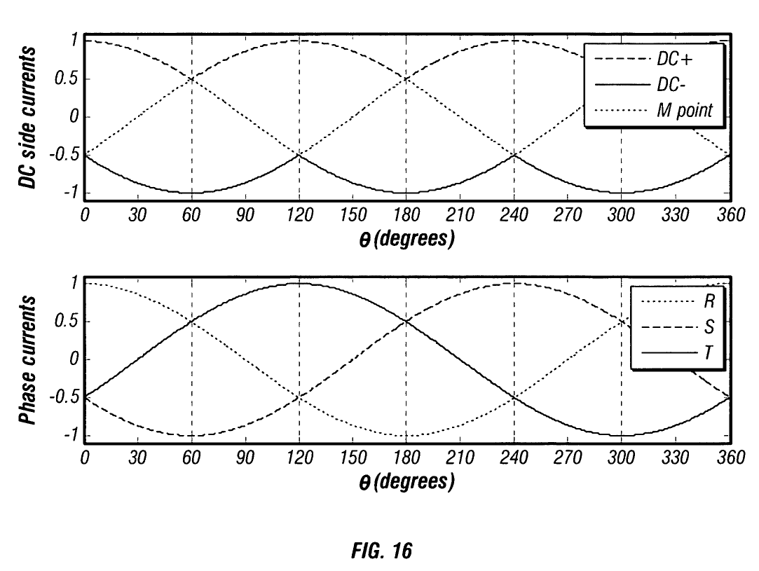

FIG. 16 illustrates the ideal DC positive and negative currents (DC+ and DC−) in accordance with several embodiments of the invention. The DC positive and negative currents (DC+ and DC−) are independently controlled by the DC side to follow the same shape as the input voltages, thus reducing the total harmonic distortion (THD) and increasing the power factor (PF) to near unity. FIG. 16 shows the current waveforms from the DC side and the AC side. The vertical dashed lines show the instants when the conducting low-speed bidirectional switch is changed. The DC+current is controlled with the upper unidirectional switch of the TLB and the DC− current with the lower unidirectional switch. The mid-point current has about half the root mean square (RMS) value of the phase currents; hence conduction power losses in the switches are comparatively small. The phase currents are divided in three parts: the upper part (when they flow through the upper diodes of the rectifier bridge), the middle part (when they flow through the bidirectional switches) and the lower part (they flow through the lower diode of the rectifier bridge). Hence, the sinusoidal waveform is accomplished by controlling the phase currents in parts.

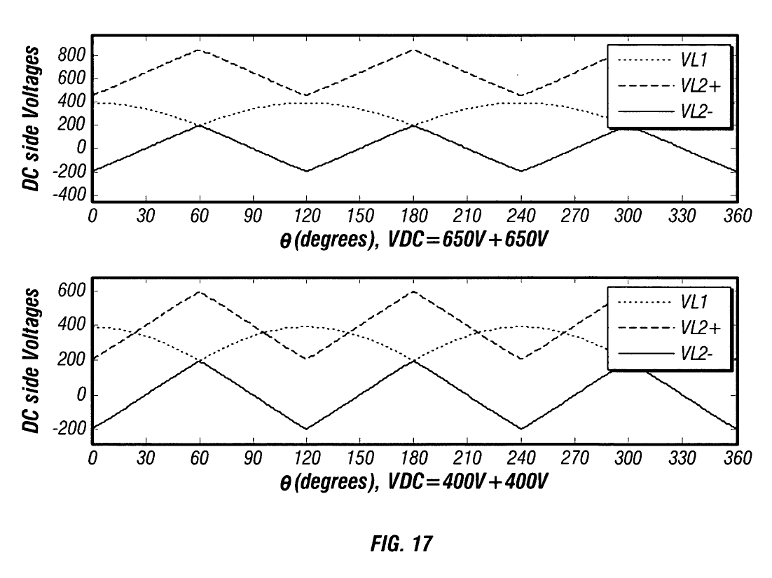

FIG. 17 illustrates the voltages of the converter at the upper part in accordance with the embodiments of the invention shown in FIGS. 2, 3, 4 and 5. The boost inductor left voltage is the input phase voltage (VL1). The current controller uses the unidirectional switches to apply a high voltage (VL2+=VM+VDC/2) or a low voltage (VL2−=VM), in order to set a negative or a positive current slope, respectively. When the DC bus voltage is not high enough, the high-voltage (VL2+) is not higher than the inductor input voltage, and the inductor current cannot be controlled. In the top graph of FIG. 17, the DC bus voltage is 650V+650V and VL2+ is always higher than the input voltage (VAC=480VRMS). When the DC voltage is not high enough, as illustrated in the bottom graph of FIG. 17, the input peak voltage is higher than VL2+, and the system cannot correctly control the phase currents. With the addition of the high-speed bidirectional switch, included in embodiments of FIGS. 8, 9, 10, 11, 12 and 13, the minimum DC voltage limit can be reduced in more than 40%.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A three phase AC to DC power converter comprising:
three boost inductors located respectively in each of three AC input phases;
a three phase diode bridge coupled to said three boost inductors;
at least two output regulating control switches connected in series across the output of said three phase diode bridge;
at least one pair of output capacitors connected in series across the output of said three phase diode bridge;
three bidirectional switches, wherein each bidirectional switch is coupled between a different one of said three boost inductors and a common connection node between said output capacitors and said output regulating control switches; and
a control circuit configured to (1) control said output regulating control switches, (2) close the bi-directional switch coupled to the boost inductor connected in the middle input phase, and (3) open the bi-directional switches coupled to the boost inductors connected in the maximum and minimum phases.

2. The three phase AC to DC power converter of claim 1, wherein the bidirectional switches comprise two insulated gate bipolar transistors with anti-parallel diode, connected in series and opposite direction.

3. The three phase AC to DC power converter of claim 1, wherein said control circuit actively controls current in the maximum and minimum phases and does not actively control current in the middle phase.

4. The three phase AC to DC power converter of claim 1, wherein the bidirectional switches are configured for low-speed switching operation.

5. The three phase AC to DC power converter of claim 1, wherein the low-speed bidirectional switches comprise two metal-oxide-semiconductor field-effect transistors connected in series and opposite direction.

6. The three phase AC to DC power converter of claim 1, wherein the output regulating control switches comprise one or more insulated gate bipolar transistors.

7. The three phase AC to DC power converter of claim 1, wherein the output regulating control switches comprise one or more metal-oxide-semiconductor field-effect transistors.

8. The three phase AC to DC power converter of claim 1, wherein the output regulating control switches are configured for high-speed operation.

9. The three phase AC to DC power converter of claim 1, wherein said control circuit is configured to maintain all of said bidirectional switches open in an input phase dropout fault condition.

10. The three phase AC to DC power converter of claim 1, wherein said bi-directional switches are integrated with said three phase rectifier.

11. The three phase AC to DC power converter of claim 1, wherein said bi-directional switches comprise thyristors or gate turn-off (GTO) thyristors.

12. A three phase AC to DC power converter comprising:
a first voltage sensor measuring voltage across a first output capacitance;
a second voltage sensor measuring voltage across a second output capacitance;
an error signal generator coupled to outputs of said voltage sensors and configured to generate at least a first error signal R−T+D and a second error signal R−T−D, where R is the voltage reference, T is the sum of the voltage across the first and second output capacitances and D is the difference between these voltages;
a first current sensor in a first current path;
a second current sensor in a second current path;
a input sensing circuit having as an input three input phase voltages and having a first output signal derived from the phase having the maximum voltage, a second output signal derived from the phase having the minimum voltage; and a third output signal comprising an identification of a phase having a middle voltage between the maximum and minimum voltages;
a first mixer having as inputs the first error signal from the error signal generator and the first output signal from the input sensing circuit;
a second mixer having as inputs the second error signal from the error signal generator and the second output signal from the input sensing circuit; and
a pulse width modulation control circuit controlling the duty cycle of inductor current control switches based at least in part on outputs of the first current sensor and the first mixer and the second current sensor and the second mixer; and
a switching circuit having as an input said third output signal from said input sensing circuit and configured to couple the input phase identified by said third output signal to a common connection point between said first output capacitance and said second output capacitance.

13. The three phase AC to DC power converter of claim 12, wherein the switching circuit comprises three low-speed bidirectional switches.

14. The three phase AC to DC converter of claim 13, wherein each low-speed bidirectional switch comprises two insulated gate bipolar transistors, with anti-parallel diode, connected in series and opposite directions.

15. The three phase AC to DC power converter of claim 13, wherein each low-speed bidirectional switch comprises two metal-oxide-semiconductor field-effect transistors connected in series.

16. The three phase AC to DC power converter of claim 13, wherein the switching circuit additionally comprises at least one high-speed bidirectional switch.

17. The three phase AC to DC power converter of claim 16, wherein the pulse width modulation control circuit also controls the duty cycle of said at least one high-speed bidirectional switch based at least in part on outputs of the first current sensor and the first mixer and the second current sensor and the second mixer.

18. The three phase AC to DC power converter of claim 12, wherein the first current sensor is in a positive rectified current path, and the second current sensor is in a negative rectified current path.

19. The three phase AC to DC power converter of claim 12, wherein the first and second current sensors are placed in two of the three input phases, and the third phase current is computed as the negative of the sum of the two measured phase currents.

20. A method of producing a regulated DC voltage from a three phase AC input voltage, the method comprising actively controlling only the currents in the input maximum voltage phase and the input minimum voltage phase.

21. The method of claim 20, additionally comprising sensing current in a positive DC output of a three phase bridge rectifier, and sensing current in a negative DC output of said three phase bridge rectifier.

22. A three phase AC to DC power converter comprising:
a three phase diode bridge;
at least two output regulating control switches connected in series across the output of said three phase diode bridge;
at least one pair of output capacitors connected in series across the output of said three phase diode bridge; and
means for actively controlling only the currents in the maximum voltage input phase and the minimum voltage input phase.

23. A three phase AC to DC power converter comprising:
a three phase diode bridge;
at least two output regulating control switches connected in series across the output of said three phase diode bridge;
at least one pair of output capacitors connected in series across the output of said three phase diode bridge; and
three low speed bidirectional switches, wherein each low speed bidirectional switch is coupled between a different input phase and a common connection node between said output capacitors and said output regulating control switches, said coupling being made through a high speed bidirectional switch.
